(19) United States
(12) Patent Application Publication
(10) Pub. No.: US 2006/0154541 A1
(43) Pub. Date: Jul. 13, 2006

(54) Surface material with a stereoscopic visual effect

(76) Inventor: Chi-Kung Wu, Taichung Hsien (TW)

Correspondence Address: Rabin & Berdo, P.C., Suite 500, 1101 14th Street, Washington, DC, 20005, US

(21) Appl. No.: 11/030,168

(22) Filed: Jan. 7, 2005

(51) Int. Cl. B32B 27/12; B32B 27/04; B32B 27/14; B32B 5/12

(52) U.S. Cl. 442/43; 428/196; 442/2; 442/58

(57) ABSTRACT

A surface material with a stereoscopic effect has a substrate and a PU meshed layer. The substrate has a first pattern. The PU meshed layer has a second pattern similar to or the same as the first pattern and is mounted on the substrate over the first pattern at an axial deflection relative to the first pattern. Because the axial deflection makes the second pattern partially overlap and visually interact with the first pattern, a stereoscopic visual effect is created on the surface material.

### BACKGROUND OF THE INVENTION

1. Field of the Invention

The present invention relates to a surface material, and more particularly to a surface material that is durable and has a special stereoscopic visual effect.

2. Description of Related Art

Conventional surface materials used on purses and shoes are made of printed polyurethane (PU) or polyvinyl chloride (PVC) sheets and are substantially two types in different materials and structures.

With reference to FIGS. 4 and 5, the first type of surface material is made of a non-ventilative transparent PU sheet (40) with a top face and a bottom face. The PU sheet (40) is pressed by a mold to form wave grooves (not numbered) and a background wave pattern (50) is printed on the bottom face. When the PU sheet (40) waves, the background wave pattern (50) presents a visual illusion mimicking waving animation. However, the PU sheet (40) is usually scratched, and the background wave pattern (50) is damaged when the surface material is manufactured. The quality of the first type of surface material is poor. Moreover, the first type of surface material is heavy because it is made completely of polyurethane.

With reference to FIGS. 6 and 7, the second type of surface material is composed of two layers of ventilative meshed cloth (60, 70) glued together. Although the second type of surface material is lighter than the first one because the layers of cloth (60, 70) substitute for the PU sheet (40), the outer layer on the second type of surface material easily wrinkles, detaches from an inner layer and wears out after abrading. Therefore, the second type of surface material has poor quality in appearance and is not durable.

The present invention has arisen to mitigate or obviate the disadvantage of the conventional surface materials.

### SUMMARY OF THE INVENTION

The first main objective of the present invention is to provide a surface material that has a stereoscopic visual effect to increase attraction.

The second main objective of the present invention is to provide a surface material that is manufactured easily and is durable.

To achieve the foregoing main objectives, the surface material in accordance with the present invention comprises a substrate and a PU meshed layer. The substrate has a first pattern. The PU meshed layer forms a second pattern and is mounted on the substrate over the first pattern. The second pattern has an axial deflection relative to the first pattern on the substrate.

Because the angle deflection makes the second pattern partially overlap and interact visually with the first pattern, a stereoscopic vision effect is created on the surface material.

Further benefits and advantages of the present invention will become apparent after a careful reading of the detailed description with appropriate references to the accompanying drawings.

### BRIEF DESCRIPTION OF THE DRAWINGS

FIG. 1 is a perspective view of a surface material in accordance with the present invention during various stages of fabrication;

FIG. 2 is an enlarged perspective view of the surface material in FIG. 1;

FIG. 3 is a schematic cross-sectional side view of another embodiment of the surface material in accordance with the present invention during various stages of fabrication;

FIG. 4 is a perspective view of a first conventional surface material in accordance with the prior art;

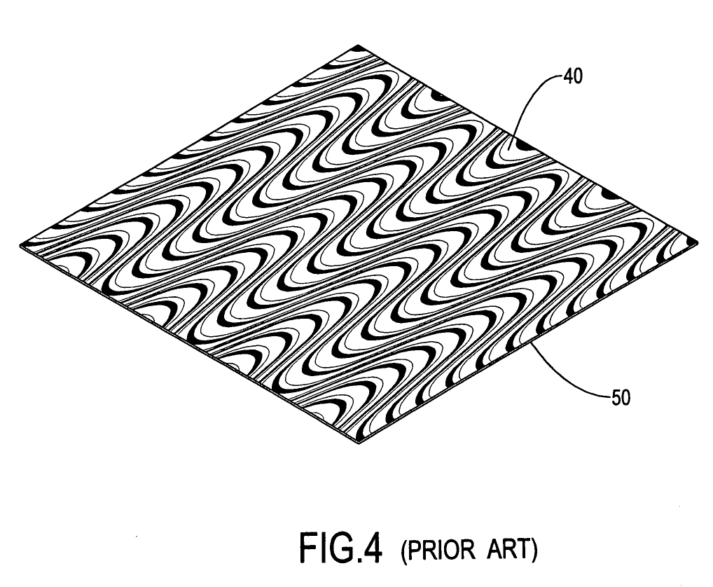

FIG. 5 is a schematic cross-sectional side view of the first conventional surface material in FIG. 4 during various stages of fabrication;

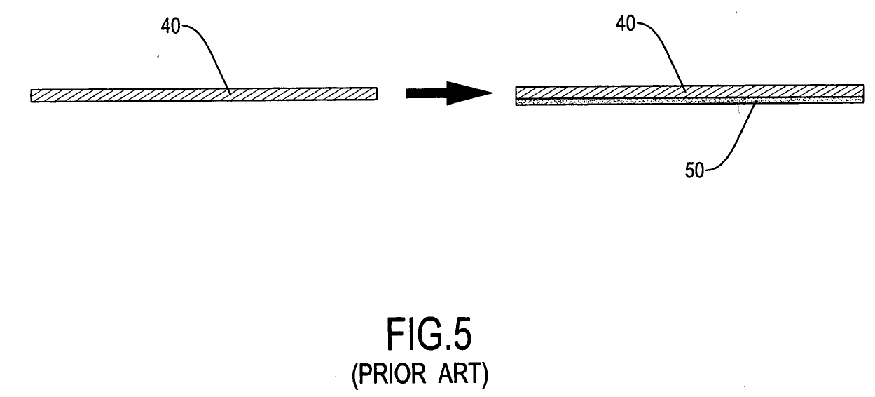

FIG. 6 is a schematic perspective view of a second conventional surface material in accordance with the prior art during various stages of fabrication; and

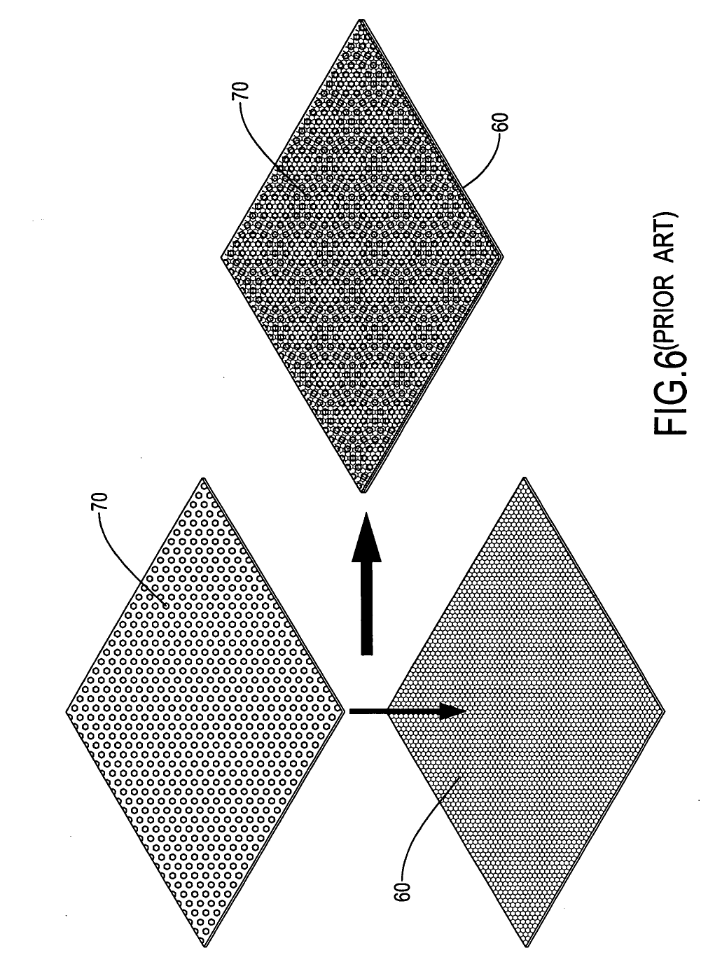

FIG. 7 is a schematic cross-sectional side view of the second conventional surface material in FIG. 6 during various stages of fabrication.

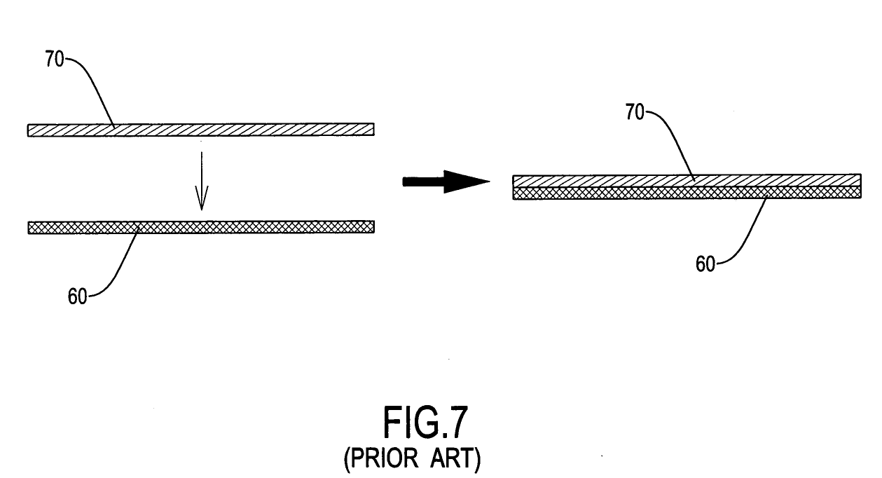

### DETAILED DESCRIPTION OF THE PREFERRED EMBODIMENT

A surface material in accordance with the present invention comprises a substrate and a PU meshed layer. The substrate has a first pattern. The PU meshed layer is mounted on the substrate over the first pattern at an axial deflection relative to the first pattern and has a second pattern similar to or the same as the first pattern. Because the axial deflection makes the second pattern partially overlap and visually interact with the first pattern, a stereoscopic visual effect is created on the surface material.

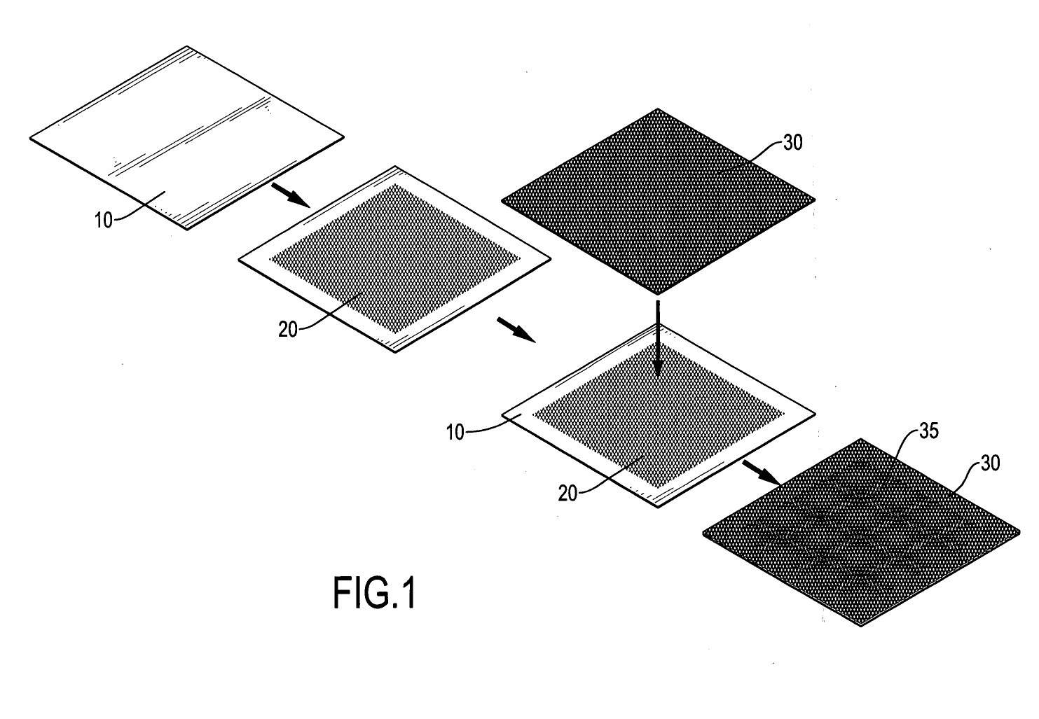

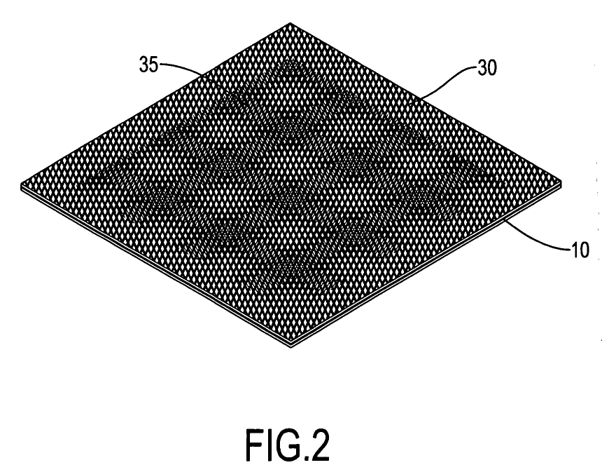

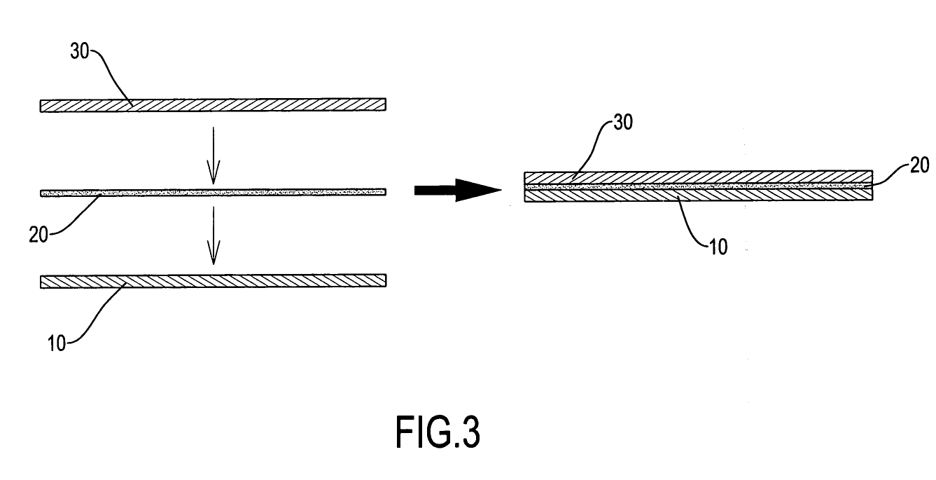

With reference to FIGS. 1 to 3, a preferred embodiment of the surface material in accordance with the present invention has a substrate (10), a printed pattern (20) and a PU meshed layer (30).

The substrate (10) is selectively made of ventilative materials such as knitted cloth or non-ventilative materials such as a plastic membrane and preferably is made of cloth or leather. The substrate (10) has a top face and a regular mesh pattern formed on the top face. Preferably, the regular mesh pattern is plaid made by printing to achieve the printed pattern (20). Selectively, the regular mesh pattern may be an original textile pattern of a cloth substrate. Moreover, the first pattern can be irregular.

The PU mesh layer is made by injection molding and thermally attached to the substrate (10). The PU mesh layer (30) is also plaid and has a thickness. The PU mesh layer (30) has a second pattern the same as the first pattern in the present embodiment and mounted over the substrate (10) at a 5° axial misalignment between the first and second patterns. After overlapping the two patterns, the surface material has a new crisscross pattern (35). Because lines of the second pattern partially cover lines of the first pattern and partially do not, darker areas of the crisscross pattern (35) are formed where lines of the second and first patterns do not overlap. In a similar but contrary manner, lighter areas within the crisscross pattern (35) are formed where lines of the second and first patterns overlap each other to reveal the substrate (10). Therefore, the visual illusion caused from the angular misalignment of the two patterns causes the crisscross pattern (35) to gradually become darker in some areas and lighter in other areas and gives the surface material a stereoscopic visual effect.

The stereoscopic visual effect can be varied easily by changing the first and second patterns in shape, the density of the lines in the patterns or the degree of axial misalignment between the two patterns. Therefore, the surface material of the present invention has versatile modifications.

Characteristics of the surface material in the present invention have the following advantages.

1. In comparison with the second type of conventional surface material, the PU mesh layer (30) is not easily detached from the substrate (10) and the surface material is not easily deformed because the PU mesh layer (30) is attached and merged thermally to the substrate (10). Therefore, appearance of the surface material is neat and has fine quality. Moreover, the PU mesh layer (30) has better abrasive durability than the cloth in the second type of the conventional surface material.

2. In comparison with the first type of conventional surface material, only the PU mesh layer (30) is made of polyurethane in the surface material of the present invention. Therefore, the surface material in the present invention weights much less than the first conventional one.

3. The surface material in the present invention can have multiple variations by simply changing the first and second patterns in shape, line density and angular misalignment between the two patterns.

Although the invention has been explained in relation to its preferred embodiments, many other possible modifications and variations can be made without departing from the spirit and scope of the invention as hereinafter claimed.

What is claimed is:

1. A surface material with a stereoscopic effect, the surface material comprising:
a substrate having a first pattern; and
a PU meshed layer forming a second pattern, mounted on the substrate over the first pattern and having an axial deflection relative to the first pattern on the substrate.

2. The surface material as claimed in claim 1, wherein the substrate is made of a ventilative material.

3. The surface material as claimed in claim 1, wherein the substrate is made of a non-ventilative material.

4. The surface material as claimed in claim 1, wherein the first pattern is originally formed with the substrate.

5. The surface material as claimed in claim 1, wherein the first pattern is printed on the substrate.

6. The surface material as claimed in claim 5, wherein the first pattern and the second pattern are the same.

7. The surface material as claimed in claim 6, wherein the first pattern and the second pattern are plaid.

8. The surface material as claimed in claim 1, wherein PU mesh layer is made by injection mold and thermally attached and merged to the substrate.
